(19) United States
(12) Patent Application Publication
(10) Pub. No.: US 2025/0303399 A1
(43) Pub. Date: Oct. 2, 2025

(54) FLUID CATALYTIC CRACKING CATALYST AND METHOD FOR PRODUCING SAME

(71) Applicant: JGC CATALYSTS AND CHEMICALS LTD., Kanagawa (JP)

(72) Inventors: Hiroshi Shintaku, Fukuoka (JP); Tatsuaki Hasegawa, Fukuoka (JP); Takaki Mizuno, Fukuoka (JP); Naoyuki Kido, Fukuoka (JP)

(21) Appl. No.: 19/090,647

(22) Filed: Mar. 26, 2025

(30) Foreign Application Priority Data
Mar. 29, 2024 (JP) 2024-056817

(51) Int. Cl. B01J 29/08; B01J 21/04; B01J 21/16; B01J 35/30; B01J 35/32; B01J 35/40; B01J 35/61; B01J 37/00; B01J 37/04; B01J 37/10; C10G 11/04

(52) U.S. Cl. CPC B01J 29/088; B01J 21/04; B01J 21/16; B01J 35/32; B01J 35/393; B01J 35/40; B01J 35/613; B01J 35/615; B01J 37/0045; B01J 37/04; B01J 37/10; C10G 11/04

(57) ABSTRACT

Provided is a fluid catalytic cracking catalyst including faujasite-type zeolite, boehmite, a binder, and clay minerals, and satisfying the following formulas (1) and (2) in powder X-ray diffraction analysis:

$$A / B \leq 1.2 \qquad ( 1 )$$

$$A / C \geq 0.8 \qquad ( 2 )$$

in the formulas (1) and (2), A is an integrated intensity of a diffraction peak attributed to (020) plane of the boehmite, B is an integrated intensity of a diffraction peak attributed to (120) plane of the boehmite, and C is an integrated intensity of a diffraction peak attributed to (331) plane of the faujasite-type zeolite.

### CROSS-REFERENCE TO RELATED APPLICATION

This application is based on Japanese Patent Application No. 2024-056817 filed with the Japan Patent Office on Mar. 29, 2024, the entire content of which is hereby incorporated by reference.

### BACKGROUND

### 1. Technical Field

The present disclosure relates to a fluid catalytic cracking catalyst and a method for producing the same.

### 2. Related Art

For the purpose of increasing yield of gasoline fraction in fluid catalytic cracking, various technologies have been developed in relation to catalysts used in the fluid catalytic cracking of hydrocarbon oils (hereinafter also referred to as “FCC catalysts” or “fluid catalytic cracking catalysts”) and the method for producing the same.

For example, an object of the technology disclosed in JP-A-2011-088137 is to provide a catalytic cracking catalyst that can efficiently obtain a gasoline fraction in a high yield by simultaneously improving cracking ability of heavy fractions, reducing an amount of coke produced, and improving gasoline yield in the catalytic cracking of hydrocarbon oils. Specifically, a catalytic cracking catalyst for hydrocarbon oils is disclosed that contains boehmite, crystalline aluminosilicate, silicon oxide derived from silica sol, and clay minerals, which have a median diameter of 30 μm or less.

In addition, JP-T-2005-532146 discloses a zeolite-based fluid catalytic cracking catalyst that passivates nickel and vanadium during catalytic cracking. According to description of a method for producing the catalyst, first, microspheres containing kaolin, a binder, and dispersible boehmite alumina are produced. Subsequently, the microspheres are converted by a standard in situ Y zeolite growth procedure to produce a Y-containing catalyst. Furthermore, an FCC catalyst containing transition alumina obtained from boehmite is produced by exchange with ammonium and then rare earth cations, and appropriate firing.

### SUMMARY

A fluid catalytic cracking catalyst according to the present embodiment includes faujasite-type zeolite, boehmite, a binder, and clay minerals, and satisfying the following formulas (1) and (2) in powder X-ray diffraction analysis:

$$A / B \leq 1.2 \qquad ( 1 )$$

$$A / C \geq 0.8 \qquad ( 2 )$$

in the formulas (1) and (2), A is an integrated intensity of a diffraction peak attributed to (020) plane of the boehmite, B is an integrated intensity of a diffraction peak attributed to (120) plane of the boehmite, and C is an integrated intensity of a diffraction peak attributed to (331) plane of the faujasite-type zeolite.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details.

Among LPG obtained by fluid catalytic cracking of hydrocarbon oils, olefins (for example, propylene or butenes including 1-butene, 2-butene, and isobutene) are useful as raw materials for the petrochemical industry. Therefore, catalysts that can produce gasoline and these olefins in high yields are extremely useful industrially.

Therefore, an object of the present embodiment is to provide an FCC catalyst capable of fluid catalytic cracking of hydrocarbons to have a high gasoline yield and high LPG olefinicity (that is, a high proportion of propylene and butenes in LPG having 3 to 4 carbon atoms), and a method for producing the catalyst.

A fluid catalytic cracking catalyst according to the present embodiment includes faujasite-type zeolite, boehmite, a binder, and clay minerals, and satisfying the following formulas (1) and (2) in powder X-ray diffraction analysis:

$$A / B \leq 1.2 \qquad ( 1 )$$

$$A / C \geq 0.8 \qquad ( 2 )$$

in the formulas (1) and (2), A is an integrated intensity of a diffraction peak attributed to (020) plane of the boehmite, B is an integrated intensity of a diffraction peak attributed to (120) plane of the boehmite, and C is an integrated intensity of a diffraction peak attributed to (331) plane of the faujasite-type zeolite.

Further, the method for producing the fluid catalytic cracking catalyst according to the present embodiment includes the following steps (α), (β), and (γ). In the step (α), an aggregate of boehmite crystals having the following properties (i) to (iv) is prepared. In the step (β), a catalyst raw material slurry is prepared that contains faujasite-type zeolite, the aggregate of boehmite crystals, a binder-forming component, and clay minerals. In the step (γ), the catalyst raw material slurry is spray-dried to form particles.
(i) The boehmite crystals have a crystallite diameter of 10 to 70 nm. The crystallite diameter is calculated from a peak of the (020) plane in X-ray diffraction measurement.
(ii) The aggregate has a specific surface area of 40 to 150 m²/g. The specific surface area is measured by a nitrogen adsorption method.
(iii) The aggregate has a d₅₀ (median diameter) of 2.0 to 10 μm on a volume basis in particle size distribution. The median diameter is measured by a laser diffraction/scattering method.
(iv) A compact bulk density (CBD) of the aggregate is 0.20 to 0.50 g/ml.

By using the FCC catalyst according to the present embodiment, it is possible to carry out the fluid catalytic cracking of hydrocarbons to achieve a high gasoline yield and high LPG olefinicity.

In addition, it is possible to carry out the fluid catalytic cracking of hydrocarbons to achieve a high gasoline yield and high LPG olefinicity by using the FCC catalyst that can be produced by the method for producing the FCC catalyst according to the present embodiment.

The present embodiment will be described in detail below.

### Fluid Catalytic Cracking Catalyst

The fluid catalytic cracking catalyst (FCC catalyst) (for hydrocarbon oils) according to the present embodiment contains faujasite-type zeolite, boehmite, a binder, and clay minerals, and has physical properties described below.

### Catalyst Components

### Faujasite-Type Zeolite

The FCC catalyst according to the present embodiment contains faujasite-type zeolite (hereinafter also simply referred to as “zeolite”).

As the faujasite-type zeolite, ultra-stable Y-type zeolite is preferred. Examples of ultra-stable Y-type zeolites include ultra-stable Y-type zeolite (USY) and rare-earth metal-exchanged ultra-stable Y-type zeolite (hereinafter also referred to as “REUSY”). The REUSY is prepared, for example, by introducing a rare earth metal into the USY by ion exchange.

The zeolite content in the FCC catalyst of the present embodiment is, for example, 15 to 40 mass %. Here, when the content is equal to or more than a lower limit, the FCC catalyst of the present embodiment exhibits sufficient activity. On the other hand, when the content is equal to or less than an upper limit, the FCC catalyst of the present embodiment can prevent overcracking, reduced gasoline selectivity, and reduced LPG olefinicity caused by excessively high activity. The zeolite content is preferably 20 to 38 mass %, more preferably 22 to 35 mass %, and particularly preferably 24 to 34 mass %.

Note that components and raw materials constituting the FCC catalyst according to the present embodiment may contain water. In the present embodiment, content of the components and an amount of each raw material used are expressed as amounts excluding water (may also be referred to as “solid content concentration”).

### Boehmite

The FCC catalyst according to the present embodiment contains the boehmite. The boehmite is preferably the aggregate of boehmite crystals having the following properties (i) to (iv).
(i) The crystallite diameter of the boehmite crystals is 10 to 70 nm, preferably 12 to 60 nm, more preferably 15 to 50 nm, still more preferably 18 to 35 nm, and particularly preferably 23 to 33 nm. The crystallite diameter is calculated from the peak of the (020) plane in the X-ray diffraction measurement.
(ii) The specific surface area of the aggregate is 40 to 150 m²/g, preferably 60 to 145 m²/g, more preferably 70 to 140 m²/g, and still more preferably 80 to 120 m²/g. The specific surface area is measured by the nitrogen adsorption method.
(iii) An average particle diameter of the aggregate is 2.0 to 10 μm, preferably 4.0 to 9.5 μm, and more preferably 6.0 to 9.0 μm. The average particle diameter is measured by the laser diffraction/scattering method.
(iv) The compact bulk density (CBD) of the aggregate is 0.20 to 0.50 g/ml.

The above-mentioned boehmite preferably forms a card house structure. That is, the boehmite is preferably an aggregate of plate-like boehmite crystals. In this aggregate, normal directions of main faces of the plate-like boehmite crystals are not aligned in one direction. That is, the plate-like boehmite crystals are aggregated so that normal lines of the main faces point in random directions. Gaps between the boehmite crystals thus formed improve diffusibility of feedstock oil molecules or product oil molecules. Therefore, an FCC reaction using the catalyst of the present embodiment exhibits high gasoline selectivity, high LPG olefinicity, high bottom cracking ability, and low coke selectivity.

The fact that the boehmite forms the card house structure can be confirmed, for example, by observing the FCC catalyst according to the present embodiment with a scanning electron microscope (SEM) (for example, a scanning electron microscope 5-5500 manufactured by Hitachi High-Tech Corporation). Observation conditions are, for example, an accelerating voltage of 30,000 volts and a magnification of 50,000 to 300,000 times.

The content of the boehmite in terms of Al₂O₃ in the FCC catalyst according to the present embodiment is, for example, 10 to 50 mass %. Here, when the content is equal to or more than a lower limit, it is considered that the gaps formed by the boehmite crystals in the aggregate of boehmite crystals described below can be sufficiently provided to the FCC catalyst. In this case, the FCC catalyst has good activity. On the other hand, when the content is equal to or less than an upper limit, the FCC catalyst has good wear resistance. The content of the boehmite is preferably 13 to 45 mass %, more preferably 15 to 40 mass %, and particularly preferably 20 to 35 mass %.

### Binder

The FCC catalyst according to the present embodiment contains the binder. The binder is usually a silica-based binder. The silica-based binder is formed from a silica-based binder-forming component described below. When the binder is the silica-based binder, formation of coke during the fluid catalytic cracking is suppressed.

The binder content in the FCC catalyst of the present embodiment is, for example, 10 to 30 mass %. Here, when the content is equal to or more than a lower limit, the FCC catalyst has good wear resistance. On the other hand, when the content is equal to or less than an upper limit, a sufficient amount of active components such as zeolite can be blended. Therefore, the FCC catalyst has good activity. The binder content is preferably 12 to 26 mass %, and more preferably 14 to 24 mass %.

### Clay Minerals

The FCC catalyst according to the present embodiment contains the clay minerals. The clay minerals that act as extenders are clay and/or clay minerals. Examples of the clay minerals include kaolin, bentonite, halloysite, and montmorillonite. Among these exemplified clay minerals, the kaolin is preferred.

The clay mineral content in the FCC catalyst according to the present embodiment is, for example, 15 to 50 mass %. Here, when the content is equal to or more than a lower limit, the FCC catalyst is good in, for example, maintenance of pore structure, maintenance of catalyst shape, wear resistance, and fluidity. On the other hand, when the content is equal to or less than an upper limit, a ratio of zeolite components in the FCC catalyst is high. Therefore, the FCC catalyst has good activity. The clay mineral content is preferably 18 to 45 mass %, and more preferably 20 to 40 mass %.

### Rare Earth Metal

The FCC catalyst according to the present embodiment may contain a rare earth metal (RE). Examples of the rare earth metal include cerium (Ce), lanthanum (La), praseodymium (Pr), and neodymium (Nd). One of the exemplified rare earth metals may be used alone. Two or more rare earth metals may be used.

The rare earth metal (RE) content in terms of RE₂O₃ in the FCC catalyst according to the present embodiment is preferably 0.5 to 3.5 mass %. Here, when the content is equal to or more than a lower limit, hydrothermal resistance of the zeolite is improved. Therefore, the FCC catalyst has good activity. On the other hand, when the content is equal to or less than an upper limit, an amount of the rare earth metal used can be reduced. Therefore, the FCC catalyst is excellent in economic efficiency. The rare earth metal (RE) content in terms of RE₂O₃ is more preferably 0.7 to 3.0 mass %.

### Additives

The FCC catalyst according to the present embodiment may contain components other than those described above to the extent that the effects of the present embodiment are not impaired. Examples of such components include silica alumina, activated alumina, aluminum hydroxide (for example, gibbsite), phosphorus-alumina particles, crystalline calcium aluminate, sepiolite, barium titanate, calcium stannate, strontium titanate, manganese oxide, magnesia, and magnesia-alumina. Furthermore, for example, CO combustion promoting components (Pt and Pd) or desulfurizing oxide components (ceria and magnesia) may be contained in the FCC catalyst.

### Catalyst Properties

### Formulas (1) and (2)

The FCC catalyst according to the present embodiment satisfies the following formulas (1) and (2) in the powder X-ray diffraction analysis.

$$A / B \leq 1.2 \qquad ( 1 )$$

[in the formula, A is the integrated intensity of the diffraction peak attributed to the (020) plane of the boehmite, and B is the integrated intensity of the diffraction peak attributed to the (120) plane of the boehmite]

$$A / C \geq 0.8 \qquad ( 2 )$$

[in the formula, A is the integrated intensity of the diffraction peak attributed to the (020) plane of the boehmite, and C is the integrated intensity of the diffraction peak attributed to the (331) plane of the faujasite-type zeolite]

Values of A/B and A/C can be determined by performing the powder X-ray diffraction analysis using the following method or a method equivalent thereto.

### (Method for Calculating A/B and A/C)

A measurement sample is subjected to X-ray diffraction analysis using an X-ray diffraction device (for example, MiniFlex manufactured by Rigaku Corporation) under the following conditions.
Scan axis: 2θ/θ
Radiation source: CuKα
Measurement method: continuous
Voltage: 40 kV
Current: 15 mA
Measurement range: from start angle 2θ=5° to end angle 2θ=90°
Sampling width: 0.020°
Scan speed: 10.000°/min

From an obtained X-ray diffraction pattern, the integrated intensity (A), the integrated intensity (B), and the integrated intensity (C) are calculated using analysis software (for example, PDXL2 manufactured by Rigaku Corporation). The integrated intensity (A) is the integrated intensity of the diffraction peak (2θ=14.0 to 15.0°) attributed to the (020) plane of the boehmite. The integrated intensity (B) is the integrated intensity of the diffraction peak (2θ=28.0 to 28.5°) attributed to the (120) plane of the boehmite. The integrated intensity (C) is the integrated intensity of the diffraction peak (2θ=15.5 to 16.0°) attributed to the (331) plane of the ultra-stable Y-type zeolite. From these integrated intensity values, the values of A/B and A/C are calculated.

A/B is preferably 1.1 or less. A lower limit of the A/B may be, for example, 0.9. The A/B can be increased or decreased, for example, by adjusting hydrothermal treatment temperature, hydrothermal treatment time, amount of inorganic basic compound, or ratio of gibbsite raw material to pseudo-boehmite when the boehmite to be blended in the FCC catalyst is prepared by hydrothermal treatment.

Although it is not necessarily clear, it is considered that the smaller the value of A/B, the smaller an amount of stacked aggregates in which the (020) planes of the plate-like boehmite crystals are in contact with each other in the catalyst. Therefore, it is considered that instead, proportion of aggregates containing the plate-like boehmite crystals that are randomly combined like a house of cards is high.

Further, the value of A/C is preferably 0.9 or more, more preferably 1.1 or more, and still more preferably 1.3 or more. An upper limit of the A/C may be, for example, 1.5. The A/C tends to correspond to a ratio of the boehmite content to the zeolite content in the FCC catalyst and degree of crystallinity of the boehmite crystals.

Here, the smaller the value of A/B and the larger the value of A/C, the higher the gasoline selectivity and LPG olefinicity of the FCC catalyst according to the present embodiment tend to be. A reason for this is not necessarily clear. However, since the value of A/C is large, it is considered that fully grown boehmite crystals reduce acid sites and increase the gasoline selectivity. Here, the acid sites can cause coke formation. Then, it is considered that the acid sites are particularly abundant in amorphous components containing crystals that have not grown sufficiently. In addition, since the value of A/B is small, it is considered that there is a large amount of the aggregate of boehmite crystals with large crystal gaps. In this case, the diffusibility of the feedstock oil molecules and the product oil molecules is increased. Then, desorption of reaction molecules is promoted. Therefore, the reaction molecules are less susceptible to excessive hydrogen transfer reaction at the acid sites of the zeolite. As a result, it is considered that decrease in olefins is suppressed.

### Specific Surface Area

A specific surface area of the FCC catalyst according to the present embodiment is preferably 200 to 350 m²/g, and more preferably 200 to 300 m²/g. The specific surface area is measured by the nitrogen adsorption method.

### Matrix Specific Surface Area

In the present embodiment, a matrix specific surface area after pseudo-equilibrium treatment is preferably 10 to 40 m²/g, and more preferably 20 to 39 m²/g. The matrix specific surface area is determined by t-plot analysis of a nitrogen adsorption isotherm obtained by measuring the FCC catalyst according to the present embodiment, after the pseudo-equilibrium treatment under the following conditions. Note that the matrix specific surface area is the specific surface area of the FCC catalyst excluding the zeolite.

### (Pseudo-Equilibrium Treatment Conditions)

The FCC catalyst supports 1000 ppm (based on mass of the catalyst) of nickel and 2000 ppm (based on the mass of the catalyst) of vanadium. The FCC catalyst is then steamed at 780° C. for 13 hours.

The smaller the matrix specific surface area after the pseudo-equilibrium treatment, the higher gasoline yield of the FCC catalyst according to the present embodiment tends to be. The reason for this is not necessarily clear. However, it is considered that the fully grown boehmite crystals reduce strong acid sites. Here, the strong acid sites cause coke formation. On the other hand, it is considered that the specific surface area of the boehmite crystals decreases as crystal growth progresses.

The FCC catalyst according to the present embodiment preferably satisfies the following formula (3).

$$( 1 - ( matrix specific surface area after pseudo - equilibrium treatment ) / ( matrix specific area before pseudo - equilibrium treatment ) ) \times 100 \% \geq 40 \% \qquad ( 3 )$$

(In the formula, the matrix specific surface area after the pseudo-equilibrium treatment is determined by the t-plot analysis of the nitrogen adsorption isotherm obtained by measuring the FCC catalyst after the pseudo-equilibrium treatment described above. The matrix specific surface area before the pseudo-equilibrium treatment is determined by the t-plot analysis of the nitrogen adsorption isotherm obtained by measuring the FCC catalyst before the pseudo-equilibrium treatment described above.)

The left side of the formula (3) is also referred to as “reduction rate of the matrix specific surface area by pseudo-equilibrium” or simply as “reduction rate”. The reduction rate is more preferably 45% or more, and an upper limit of the reduction rate may be, for example, 65%.

Here, a value of the reduction rate can be increased or decreased, for example, by adjusting the hydrothermal treatment temperature, the hydrothermal treatment time, the amount of inorganic basic compound, or the ratio of the gibbsite raw material to the pseudo-boehmite when the boehmite to be blended in the FCC catalyst is prepared by the hydrothermal treatment.

The greater the reduction rate, the higher the LPG olefinicity of the FCC catalyst according to the present embodiment tends to be. The reason for this is not necessarily clear. However, the more the specific surface area of the boehmite is reduced by the pseudo-equilibrium treatment before being subjected to the FCC reaction, the more inactive the boehmite is after the pseudo-equilibrium treatment. It is therefore thought that the boehmite functions efficiently as a passage for diffusing the reaction molecules.

The FCC catalyst according to the present embodiment preferably satisfies the following formula (4).

$$( matrix specific surface area after pseudo - equilibrium treatment ) / ( pore volume ) \leq 120 {m}^{2} / ml \qquad ( 4 )$$

[In the formula, the matrix specific surface area after the pseudo-equilibrium treatment is determined by the t-plot analysis of the nitrogen adsorption isotherm obtained by measuring the FCC catalyst after the pseudo-equilibrium treatment described above. The pore volume is a volume of pores having a pore diameter of 4.0 to 10,000 nm, obtained by measuring the FCC catalyst after the pseudo-equilibrium treatment described above by mercury intrusion porosimetry (mercury contact angle: 140 degrees, surface tension: 480 dyn/cm).]

A value of the left side of the formula (4) is more preferably 115 m²/ml or less. A lower limit of the left side may be, for example, 95 m²/ml.

The value of the left side of the formula (4) can be increased or decreased, for example, by adjusting the hydrothermal treatment temperature, the hydrothermal treatment time, the amount of inorganic basic compound, or the ratio of the gibbsite raw material to the pseudo-boehmite when the boehmite to be blended in the FCC catalyst is prepared by the hydrothermal treatment.

The smaller the value of the left side of equation (4), that is, the matrix specific surface area per pore volume after the pseudo-equilibrium treatment, the higher the gasoline yield of the FCC catalyst according to the present embodiment tends to be. The reason for this is not necessarily clear. However, although the pore volume of the FCC catalysts is large, the specific surface area is small. This is thought to allow large-volume pores to function efficiently as the passage for diffusing the reaction molecules.

### Method for Producing Fluid Catalytic Cracking Catalyst

The method for producing the fluid catalytic cracking catalyst (FCC catalyst) (for hydrocarbon oils) according to the present embodiment includes the following steps (α), (β), and (γ). In the step (α), an aggregate of boehmite crystals having predetermined properties is prepared. In the step (β), a catalyst raw material slurry containing the faujasite-type zeolite, the aggregate of boehmite crystals, and the binder-forming component is prepared. In the step (γ), the catalyst raw material slurry is spray-dried.

### (Step (α))

The step (α) is a step of preparing the aggregate of boehmite crystals (hereinafter also referred to as “aggregated boehmite (a)”) having the following properties (i) to (iv).
(i) The crystallite diameter of the boehmite crystals is 10 to 70 nm. The crystallite diameter is calculated from the peak of the (020) plane in the X-ray diffraction measurement.
(ii) The specific surface area of the aggregate is 40 to 150 m²/g. The specific surface area is measured by the nitrogen adsorption method.
(iii) The average particle diameter of the aggregate is 2.0 to 10 μm. The average particle diameter is measured by the laser diffraction/scattering method.
(iv) The compact bulk density (CBD) of the aggregate is 0.20 to 0.50 g/ml.

Each physical property will be described in detail.

### (i) Crystallite Diameter

The crystallite diameter of the boehmite crystals constituting the aggregated boehmite (a) is 10 to 70 nm. The crystallite diameter is calculated from the peak of the (020) plane in the X-ray diffraction measurement.

The aggregated boehmite (a) having a crystallite diameter within this range is suitable as a catalyst material. For example, by using the aggregated boehmite (a) as a matrix component, an FCC catalyst with excellent catalyst performance can be produced.

On the other hand, the aggregated boehmite (a) having a crystallite diameter excessively larger than this range is considered to be unsuitable as the catalyst material. For example, when the FCC catalyst is produced using the aggregated boehmite (a) having an excessively large crystallite diameter as the matrix component, the catalyst performance or the wear resistance may be significantly deteriorated.

The crystallite diameter is preferably 12 to 50 nm, more preferably 15 to 40 nm, still more preferably 18 to 35 nm, and particularly preferably 23 to 33 nm. The crystallite diameter is determined by the following method or a method equivalent thereto.

### Method for Calculating Crystallite Diameter

A powder of the aggregated boehmite (a) is prepared. When a form of the aggregated boehmite (a) is a slurry, for example, the slurry is dried at 130° C. for 12 hours. Thereafter, residue is ground in a mortar. Thus, the powder is collected.

Subsequently, the powder is pulverized in the mortar. In this way, the measurement sample is prepared. The X-ray diffraction pattern of the sample is obtained using the X-ray diffraction device (for example, MiniFlex manufactured by Rigaku Corporation). Then, a full width at half maximum of the peak of the (020) plane of the boehmite in the obtained X-ray diffraction pattern is measured. Then, a value calculated using the following Scherrer's formula is used as the crystallite diameter.

$$D = K λ / βcos θ$$

D: crystallite diameter (nm)
K: Scherrer constant (K=0.94 in the present disclosure)
λ: X-ray wavelength (0.15418 nm, CuKα)
β: full width at half maximum (rad)
θ: reflection angle

The crystallite diameter can be adjusted, for example, in a production method described below, by changing the time of the hydrothermal treatment, by changing a ratio of aluminum and the inorganic basic compound during the hydrothermal treatment, or by changing a mixing ratio of the gibbsite and the pseudo-boehmite.

Note that a gibbsite peak may be observed to the extent that the effects of the present embodiment are not impaired in the above-mentioned X-ray diffraction pattern. When the gibbsite peak is observed, a ratio of an integrated intensity of (002) plane of the gibbsite to an integrated intensity of the (020) plane of the boehmite by the X-ray diffraction analysis is preferably 10% or less, more preferably 5% or less, and particularly preferably 1% or less. The integrated intensity in the X-ray diffraction analysis can be determined by analyzing the X-ray diffraction pattern obtained by the above-mentioned method using X-ray diffraction analysis software (for example, PDXL2 manufactured by Rigaku Corporation). The gibbsite content can be adjusted, for example, by changing temperature or time of the hydrothermal treatment.

### (ii) Specific Surface Area

The specific surface area of the aggregated boehmite (a) is 40 to 150 m²/g. The specific surface area is measured by the nitrogen adsorption method (a method described below or a method equivalent thereto). When the specific surface area is within this range, the aggregated boehmite (a) is useful as the catalyst material. The specific surface area is preferably 60 to 145 m²/g, more preferably 70 to 140 m²/g, and still more preferably 80 to 120 m²/g.

### Method for Measuring Specific Surface Area by Nitrogen Adsorption Method

First, the powder of the aggregated boehmite (a) is prepared. When the form of the aggregated boehmite (a) is a slurry, for example, the slurry is dried at 130° C. for 12 hours, and the residue is then ground in the mortar. Thus, the powder is collected.

Subsequently, the powder collected in a magnetic crucible is fired at 600° C. for 2 hours. Thereafter, the fired powder is placed in a desiccator and cooled to room temperature. In this way, the measurement sample is prepared. Subsequently, the specific surface area of the collected 0.3 g measurement sample is measured by a BET single-point method using a fully automatic surface area measuring device.

The specific surface area can be adjusted, for example, in the production method described below, by changing the time of the hydrothermal treatment, by changing the ratio of aluminum and the inorganic basic compound during the hydrothermal treatment, or by changing the mixing ratio of the gibbsite and the pseudo-boehmite.

(iii) Average Particle Diameter

An average particle diameter of the aggregated boehmite (a) is 2.0 to 10 μm. The average particle diameter can be adjusted, for example, in the production method described below, by adjusting a blade tip speed of a stirring blade when stirring the raw materials or a holding temperature of the hydrothermal treatment. The average particle diameter is preferably 4.0 to 9.5 μm, and more preferably 6.0 to 9.0 μm.

### Method for Measuring Average Particle Diameter

In measurements using a laser diffraction/scattering particle size distribution analyzer (for example, LA-950V2 manufactured by HORIBA, Ltd.), the sample is added to a solvent (water) so that light transmittance is in a range of 70 to 95%. The particle size distribution is measured under conditions of circulation rate 5.0 L/min, ultrasonic irradiation for 1 minute, repeated 15 times, and refractive index 1.66, or conditions equivalent thereto. The d₅₀ (median diameter) on a volume basis is used as the average particle diameter.

### (iv) Compact Bulk Density (CBD)

The compact bulk density (CBD) of the aggregated boehmite (a) is 0.20 to 0.50 g/ml. In the aggregated boehmite (a) having such a small CBD, the plate-like boehmite crystals are thought to form the card house structure. That is, the CBD is small in the aggregated boehmite (a). Therefore, it is considered that the gaps between the plate-like boehmite crystals that form the card house structure are large. Therefore, it is considered that when the aggregated boehmite (a) is used as an FCC catalyst material, large gaps are formed in the FCC catalyst. In this case, feedstock oil and product oil easily diffuse. Therefore, it is considered that the catalyst performance such as conversion rate can be improved. The CBD is preferably 0.25 to 0.40 g/ml, and more preferably 0.30 to 0.40 g/ml.

### Method for Measuring CBD

First, the powder of the aggregated boehmite (a) is prepared. When the form of the aggregated boehmite (a) is a slurry, for example, the slurry is dried at 130° C. for 12 hours. Thereafter, the aggregated boehmite (a) is ground in the mortar. Thus, the powder is collected.

Subsequently, 25 g of this powder sample weighed out is transferred to a 250 ml measuring cylinder. The measuring cylinder is attached to a Tyler sieve shaker. The sample is filled by tapping with the Tyler sieve shaker over a period of 15 minutes. The measuring cylinder is removed from the Tyler sieve shaker. After a sample surface is flattened, a filling volume is read. The CBD is calculated from a weight of the powder sample and the filling volume of the powder sample.

The CBD can be adjusted, for example, by changing the mixing ratio of the gibbsite and the pseudo-boehmite in the production method described below. The production method of the aggregated boehmite (a) will be described later. In the step (α), the aggregated boehmite (a) may be prepared as a powder. Alternatively, the aggregated boehmite (a) may be prepared as a slurry. Preferably, the aggregated boehmite (a) is prepared as a slurry.

### (Step (β))

In the step (β), the faujasite-type zeolite, the aggregated boehmite (a) prepared in the step (α), the binder-forming component, water, the clay minerals, and if necessary, additives are mixed together to produce the catalyst raw material slurry.

Each of the faujasite-type zeolite, the aggregated boehmite (a), the binder-forming component, the clay minerals, and the additives may be added as a powder or may be added as a slurry. In addition, an order of adding the components does not matter so long as the slurry can be prepared without causing gelation.

### Faujasite-Type Zeolite

Details of the faujasite-type zeolite are as described above.

### Aggregated Boehmite (a)

Details of the aggregated boehmite (a) are as described above.

### Binder-Forming Component

The binder-forming component is usually the silica-based binder-forming component. The binder-forming component is prepared by mixing a silica source with an acid. Examples of the silica source include silica, silica gel (also including silica hydrogel), silica sol (also including silica hydrosol), and an aqueous solution (for example, water glass) of silicic acid (salt) (also including orthosilicic acid (salt) and metasilicic acid (salt)). For example, sodium type, potassium type, lithium type, or acid type colloidal silica can be used as the silica sol and silicate salt. Among these, an aqueous solution of the silica sol and an aqueous solution of the silicic acid (salt) are preferred. Examples of the acid include an inorganic acid. Examples of the inorganic acid include sulfuric acid, hydrochloric acid, nitric acid, and phosphoric acid, and among these, sulfuric acid, hydrochloric acid, and nitric acid are preferred, and sulfuric acid is particularly preferred.

### Clay Minerals

Details of the clay minerals are as described above.

### Additives

The catalyst raw material slurry may contain additives to the extent that the effects of the present embodiment are not impaired. Details of the additives are as described above.

### Catalyst Raw Material Slurry

A ratio of each component in the catalyst raw material slurry is appropriately set to correspond to the content of each component in the FCC catalyst according to the present embodiment described above.

The catalyst raw material slurry contains water as a dispersion medium. The catalyst raw material slurry may contain a small amount of a component other than water as the dispersion medium, such as methanol, ethanol, or acetone.

From the viewpoint of spray drying the catalyst raw material slurry without difficulty, and the like, the solid content concentration of the catalyst raw material slurry is preferably 20 to 40 mass %, and more preferably 25 to 35 mass %. A temperature of the catalyst raw material slurry is preferably 20 to 80° C., and more preferably 30 to 70° C. A viscosity of the catalyst raw material slurry is preferably 100 to 10,000 mPa·s, and more preferably 200 to 8,000 mPa·s.

### (Step (γ))

In the step (γ), the catalyst raw material slurry produced in the step (β) is spray-dried to obtain the particles (hereinafter also referred to as “spray-dried particles”).

Spray drying conditions may be appropriately changed depending on, for example, the solid content concentration or the viscosity of the catalyst raw material slurry. The spray drying conditions are not particularly limited as long as an average particle diameter of the resulting spray-dried particles is set in an average range of 50 to 90 μm, similar to that of general FCC catalyst particles.

For example, the catalyst raw material slurry placed in a slurry tank of a spray dryer is sprayed into a drying chamber through which an air stream (for example, air flow) flows. The temperature of the air stream is set, for example, in a range of 120 to 600° C. Thus, the particles (spray-dried particles) are obtained. The temperature of the air stream is lowered by spraying the catalyst raw material slurry. However, a temperature at an outlet of the drying chamber is maintained, for example, in a range of 50 to 300° C. by using a heater or the like.

A particle diameter of the spray-dried particles can be controlled by adjusting the concentration, viscosity, spray amount, or spray pressure of the catalyst raw material slurry to be sprayed, or nozzle size or hot air temperature of the spray dryer. Further, the spray-dried particles may be washed (for example, with water) and then dried. From the viewpoint of washability, a temperature of the water is preferably 40 to 80° C.

The resulting spray-dried particles can be directly used as the FCC catalyst according to the present embodiment. However, preferably, the spray-dried particles obtained in the step (γ) are subjected to a step (δ) of contacting the dried particles with water containing an ammonium salt, and a step (ε) of drying the particles that have been subjected to the step (δ), and then used as the FCC catalyst according to the present embodiment.

### (Step (δ))

In the step (δ), the spray-dried particles obtained in the step (γ) are contacted with the water containing an ammonium salt.

Examples of the ammonium salt include ammonium chloride, ammonium nitrate, ammonium sulfate, ammonium phosphate, ammonium oxalate, and ammonium acetate, and the ammonium sulfate is preferred among them.

Examples of aspects of the step (δ) include a step of separating particles from a slurry obtained by dispersing the spray-dried particles obtained in the step (γ) in the water containing an ammonium salt, and a step of pouring the water containing an ammonium salt onto the spray-dried particles obtained in the step (γ).

From the viewpoint of removing sulfate ions and the like derived from the ammonium salt, the spray-dried particles that have been contacted with the water containing an ammonium salt may be washed with water and may then be dried.

The temperature of the water used in the step (δ) is preferably 40 to 80° C. from the viewpoint of, for example, the washability. In the step (δ), the spray-dried particles obtained in the step (γ) have been contacted with the water containing an ammonium salt, and then with an aqueous solution containing a rare earth metal. This allows the rare earth metal to be introduced into the zeolite in the spray-dried particles.

In the step (δ), the spray-dried particles are preferably suspended in water to prepare a suspension. The suspension is contacted with the aqueous solution containing the rare earth metal to be ion-exchanged. Thereafter, the resulting solid content (FCC catalyst) may be separated, washed, and dried. The temperature of the water is preferably 40 to 80° C. Further, the solid content separated by filtration of the suspension may be suspended again in water. This allows unwanted soluble substances present in the spray-dried particles to be removed.

The aqueous solution containing the rare earth metal is prepared, for example, by dissolving a salt of the rare earth metal (for example, LaCl₃) in water. Concentration of the rare earth metal in the fluid catalytic cracking catalyst obtained in the step (δ) is 0.5 to 3.5 mass %, and preferably 0.7 to 3.0 mass % in terms of rare earth metal oxide (RE₂O₃). An amount or concentration of the aqueous solution containing the rare earth metal is adjusted so that the content of the rare earth metal oxide has a desired value.

When the ultra-stable Y-type zeolites is the USY, a fluid catalytic cracking catalyst containing a desired amount of the rare earth metal can be produced in the step (δ). In addition, when the catalyst raw material slurry is prepared using the REUSY in the step (β) or when the spray-dried particles containing the REUSY obtained in the step (γ) are washed, even when some of rare earth metal ions are removed from the REUSY (replaced with protons), the fluid catalytic cracking catalyst containing a desired amount of the rare earth metal can be produced in the step (δ).

### (Step (ε))

The step (ε) is a step of drying the spray-dried particles that have undergone the step (δ). The drying may be carried out, for example, by heating the spray-dried particles that have undergone the step (δ) in a dryer at 90 to 200° C. for 0.5 to 24 hours.

### Method for Producing Aggregated Boehmite (a)

The above-mentioned aggregated boehmite (a) can be produced, for example, by a method including a step (A) of producing an aggregated boehmite slurry. Furthermore, the aggregated boehmite (a) may be produced by a method including a step (B) of drying the aggregated boehmite slurry produced in the step (A).

### Step (A)

In the step (A), the aggregated boehmite slurry is produced, for example, by a method including the following first, second, and third steps.

In the first step, 75 to 95 parts by mass of gibbsite in terms of Al₂O₃, 5 to 25 parts by mass of pseudo-boehmite powder in terms of Al₂O₃ (where a total amount of the gibbsite and the pseudo-boehmite in terms of Al₂O₃ is 100 parts by mass), and water are mixed so that pH is not 7.0 or less to prepare a mixed liquid (1). The d₅₀ (median diameter) of the gibbsite is 0.5 μm or more and less than 70 μm. The median diameter is determined on a volume basis in the particle size distribution measured by the laser diffraction/scattering method. The pseudo-boehmite powder has not deflocculated. A crystallite diameter of the pseudo-boehmite powder is 2 to 6 nm. The crystal size is calculated from the peak of the (020) plane in the X-ray diffraction measurement. Further, the d₅₀ (median diameter) of the pseudo-boehmite powder is 5 to 100 μm. The median diameter is determined on a volume basis in the particle size distribution measured by the laser diffraction/scattering method.

In the second step, the inorganic basic compound is added to the mixed liquid (1) to prepare a mixed liquid (2) having a pH of 9 to 12.

In the third step, while the mixed liquid (2) is being stirred, a temperature of the mixed liquid (2) is raised at a rate of 15 to 60° C./hour. Thereafter, the mixed liquid (2) is hydrothermally treated at 150 to 190° C. for 1 to 24 hours.

### (First Step)

The first step is a step of prepare the mixed liquid (1) by mixing the gibbsite, the pseudo-boehmite, and water.

An average particle diameter of the gibbsite, that is, the d₅₀ (median diameter) on a volume basis in the particle size distribution is 0.5 μm or more and less than 70 μm. Here, when the d₅₀ is smaller than this range, it is difficult to control the reaction. Conversely, when the d₅₀ is larger than this range, the gibbsite settles quickly when suspended in water. Therefore, handling is difficult. The d₅₀ is preferably 1.0 μm or more and less than 65 μm, and more preferably 2.0 μm or more and less than 60 am. From the viewpoint of being able to shorten the hydrothermal treatment time, the d₅₀ is still more preferably 2.0 μm or more and less than 55 μm.

Examples of commercially available gibbsite include “C-303” (manufactured by Sumitomo Chemical Co., Ltd.) and “C-12” (manufactured by Sumitomo Chemical Co., Ltd.). The gibbsite may be appropriately pulverized so that the d50 is within an aforementioned range and used. For example, the gibbsite can be pulverized using a ball mill, an attritor, a bead mill, a colloid mill, or a high shear mixer.

### Method for Measuring Particle Size Distribution

A method for measuring the d₅₀, that is, the average particle diameter, of the gibbsite is the same as the method for measuring the average particle diameter of the aggregated boehmite (a) described above.

It is considered that pseudo-boehmite functions as a seed crystal (a seed) during the hydrothermal treatment. The crystallite diameter is 2 to 6 nm. When the crystallite diameter is smaller than this range, the hydrothermal treatment takes a long time. Therefore, a crystallite diameter that is too small is not preferable. When the crystallite diameter is larger than this range, it is difficult to control the reaction.

A method for calculating the crystallite diameter of the pseudo-boehmite is the same as a method for calculating the crystallite diameter of the aggregated boehmite (a) described above. The average particle diameter of the pseudo-boehmite, that is, the d₅₀ (median diameter) on a volume basis in the particle size distribution is 5 to 100 μm. Here, when the d₅₀ is within this range, the aggregated boehmite (a) functions as the seed crystal while remaining in the form of aggregate. Therefore, when the aggregated boehmite (a) comes into contact with the acid, the aggregated boehmite (a) is difficult to deflocculate. As a result, it is possible to produce the aggregated boehmite (a) having a small CBD. Conversely, when the d₅₀ is smaller than this range, the CBD of the resulting aggregate of boehmite crystals is large. If the d₅₀ is larger than this range, the pseudo-boehmite does not function as the seed crystal. The d₅₀ is preferably 40 to 70 μm.

An example of a commercially available pseudo-boehmite is “Catapal-A” (manufactured by Sasol). The pseudo-boehmite used may be appropriately pulverized in advance so that the d₅₀ is within the aforementioned range. For example, the pseudo-boehmite can be pulverized using the ball mill, the attritor, the bead mill, the colloid mill, or the high-shear mixer.

The method for measuring the d₅₀, that is, the average particle diameter of the pseudo-boehmite is the same as the method for measuring the average particle diameter of the aggregated boehmite (a) described above. When the pseudo-boehmite powder, the gibbsite, and water are mixed to prepare the mixed liquid (1), the pseudo-boehmite powder having aggregates solidified by drying functions as the seed crystal, compared to when the pseudo-boehmite slurry, the gibbsite, and water are mixed. Therefore, the aggregated boehmite can be prepared.

The pseudo-boehmite is mixed with the gibbsite and water without deflocculation. By not deflocculating the pseudo-boehmite, an aggregate of pseudo-boehmite functions as the seed crystal. Therefore, the obtained boehmite also aggregates. Then, the aggregated boehmite (a) having a card house structure is formed. Therefore, it is considered that the CBD is reduced. In addition, by not deflocculating the pseudo-boehmite, the step can be shortened. Therefore, industrially excellent economy and productivity are achieved.

The water used is preferably ion-exchanged water. The mixing ratio of the gibbsite and the pseudo-boehmite, that is, “(mass of gibbsite):(mass of pseudo-boehmite)”, is “75 to 95:25 to 5” in terms of Al₂O₃ (where a sum of both is 100). Here, when an amount of the gibbsite is too small (an amount of the pseudo-boehmite is too large), the CBD of the boehmite obtained from the boehmite slurry is large. Conversely, when the amount of the gibbsite is too large (the amount of the pseudo-boehmite is too small), the crystallite diameter of the obtained boehmite is large. On the other hand, the specific surface area of the obtained boehmite is small. This “(mass of gibbsite):(mass of pseudo-boehmite)” is preferably “75 to 90:25 to 10”, and more preferably “80 to 90:20 to 10”.

The mixed liquid (1) prepared by mixing the gibbsite, the pseudo-boehmite, and water is usually a slurry. When the gibbsite, the pseudo-boehmite, and water are mixed to prepare the mixed liquid (1), the temperature is usually 5 to 90° C., and preferably 15 to 80° C.

These components are mixed so that pH of the mixed liquid (1) is not 7.0 or less. The mixed liquid (1) is used in the next step. In this way, the pseudo-boehmite can be prevented from deflocculating under an acidic condition. That is, the pseudo-boehmite functions as the seed crystal while remaining in the form of aggregate. Therefore, the aggregated boehmite (a) having a small CBD is obtained.

### (Second Step)

The second step is a step of preparing the mixed liquid (2) having a pH of 9 to 12 by adding the inorganic basic compound to the mixed liquid (1).

Examples of the inorganic basic compound include sodium hydroxide, potassium hydroxide, and calcium hydroxide. The sodium hydroxide is preferred. The mixed liquid (2) is usually a slurry.

The specific inorganic basic compound and its amount are selected so that the pH of the resulting mixed liquid (2) is preferably 9 to 12 at 60° C. Here, when the pH is lower than this lower limit, dissolution and reprecipitation of the gibbsite or the pseudo-boehmite may not proceed sufficiently during the hydrothermal treatment. In this case, a slurry containing not only the desired boehmite but also the gibbsite is obtained. Therefore, a pH value that is too small is not preferrable. When the inorganic basic compound is added to the mixed liquid (1) to prepare the mixed liquid (2), the temperature is usually 5 to 90° C., and preferably 15 to 80° C.

### (Third Step)

The third step is a step of obtaining the aggregated boehmite slurry by subjecting the mixed liquid (2) obtained in the second step to the hydrothermal treatment.

The hydrothermal treatment temperature is usually 140 to 190° C., and preferably 150 to 190° C. The hydrothermal treatment time is usually 1 to 24 hours, and preferably 15 to 18 hours. On the other hand, when the hydrothermal treatment temperature is lower than this range, or when the hydrothermal treatment time is shorter than this range, a hydrothermal reaction may not proceed sufficiently. In this case, yield of the boehmite decreases.

Further, a temperature rise rate (that is, a rate at which the temperature of the mixed liquid (2) obtained in the second step is raised to the above-mentioned hydrothermal treatment temperature) is usually 15 to 60° C./hour, and preferably 20 to 40° C./hour. On the other hand, when the temperature rise rate is higher than this range, the hydrothermal reaction may not proceed sufficiently. In this case, the yield of the boehmite decreases.

The mixed liquid (2) can be hydrothermally treated under autogenous pressure. An autoclave is usually used for the hydrothermal treatment. The autoclave is preferably equipped with a stirring blade. By using the stirring blade to stir the mixed liquid (2), the mixed liquid (2) can be hydrothermally treated more uniformly.

Preferably, the mixed liquid (2) is stirred under gentle conditions. For example, the mixed liquid (2) is preferably stirred at a low blade tip speed. By stirring under gentle conditions, the aggregated boehmite is difficult to deflocculate even when the aggregated boehmite obtained comes into contact with the acid or is subjected to pulverization processing. On the other hand, when the mixed liquid (2) is stirred, for example, at an excessively high blade tip speed, the obtained boehmite may not be sufficiently aggregated. In this case, the CBD may increase.

### (Fourth Step)

The step (A) of producing the aggregated boehmite slurry may, if necessary, include a fourth step including washing the slurry obtained in the third step.

In the fourth step, the slurry obtained in the third step is dehydrated. The obtained solid content is washed with water (preferably ion-exchanged water). The resulting washed cake is suspended in a liquid medium (preferably water such as ion-exchanged water). In this way, a washed aggregated boehmite slurry is prepared.

The temperature of the water used for washing is preferably set at 40 to 90° C. The fourth step allows impurities (for example, sodium or sulfate) to be removed. Further, the washed cake can be resuspended in the solvent such as water. This allows concentration of the slurry to be adjusted to a desired value.

### (Aggregated Boehmite Slurry)

For example, the aggregated boehmite slurry is produced by the above-mentioned step (A). Concentration of the boehmite in terms of alumina (Al₂O₃) in the aggregated boehmite slurry produced in the above-mentioned step (A) is, for example, 5.0 to 30 mass %, preferably 8.0 to 25 mass %, and more preferably 10 to 20 mass %.

The concentration of the boehmite can be adjusted by increasing or decreasing an amount of water contained in the aggregated boehmite slurry. The aggregated boehmite slurry may contain the additives to the extent that the effects of the present embodiment are not impaired. The slurry may not contain the additives.

Examples of the additives include inorganic acids (including sulfuric acid, hydrochloric acid, nitric acid, phosphoric acid, and boric acid), inorganic bases (including sodium hydroxide, potassium hydroxide, calcium hydroxide, and ammonium hydroxide), organic acids (including formic acid, acetic acid, citric acid, malic acid, tartaric acid, gluconic acid, succinic acid, oxalic acid, and lactic acid), and thickeners (including polyvinyl alcohol, methylcellulose, gum arabic, diatomaceous earth, bentonite, polyacrylamide, polyethylene oxide, polyacrylic esters, and locust bean gum).

When the additives are included, they can be added in a usual manner at stages of the first to fourth steps However, when the additives are added at the stages of the first to third steps, an amount of the additives excluding the inorganic basic compound added in the second step is preferably 1 mass % or less based on a total content (that is, 100 mass %) of the gibbsite and the boehmite in terms of aluminum (alumina (Al₂O₃)) in the raw materials, from the viewpoint of promoting dissolution of the gibbsite as the raw material and growth of the boehmite crystals.

### Step (B)

In the step (B), the aggregated boehmite slurry produced in the step (A) is dried. Thus, the aggregated boehmite (a) is obtained.

The aggregated boehmite slurry may be washed with water before drying. A temperature of washing water is preferably 40 to 90° C. The drying may be carried out, for example, by heating the aggregated boehmite slurry after washing at 90 to 200° C. for 0.5 to 24 hours.

The resulting dried material is preferably pulverized. The pulverization can be carried out by a conventionally known method, for example, using the mortar. Further, the drying may be carried out by spray drying the aggregated boehmite slurry. In this case, concentration of the aggregated boehmite slurry may be adjusted to, for example, 5 to 30 mass % in terms of Al₂O₃ by adding water.

For example, the aggregated boehmite slurry placed in the slurry tank of the spray dryer is sprayed into the drying chamber through which the air stream (for example, air flow) flows. The temperature of the air stream is set, for example, in the range of 120 to 600° C. Thus, the particles (spray-dried particles) are obtained. The temperature of the air stream is lowered by spraying the aggregated boehmite slurry. However, the temperature at the outlet of the drying chamber is maintained, for example, in the range of 50 to 300° C. by using the heater or the like.

The particle diameter of the spray-dried particles can be controlled by adjusting, for example, the concentration, viscosity, spray amount, or spray pressure of the aggregated boehmite slurry to be sprayed, or the nozzle size or hot air temperature of the spray dryer.

### EXAMPLES

The present embodiment will be described in more detail using Examples shown below. However, the present embodiment is not limited to these Examples.

### Measurement Methods

In Examples and Comparative Examples, the properties were measured by the following methods.

### Measurement of Boehmite

### (Measurement Sample)

Powders obtained in step 2 of Production Examples and step 2 of Comparative Production Examples were used as measurement samples. However, slurries obtained in step 3 of Production Examples and step 3 of Comparative Production Examples were used as the measurement samples to measure the average particle diameter (particle size distribution (d₅₀)).

(Average Particle Diameter (Particle Size Distribution (d₅₀)))

The particle size distribution of the measurement sample was measured using the laser diffraction/scattering particle size distribution analyzer (LA-950V2) manufactured by HORIBA, Ltd. Specifically, the measurement sample was added to the solvent (water) so that the light transmittance was in the range of 70 to 95%. The particle size distribution was measured under the conditions of circulation rate 5.0 L/min, ultrasonic irradiation for 1 minute, repeated 15 times, and refractive index 1.66.

### (Crystal Structure and Crystallite Diameter)

The measurement sample pulverized in the mortar was subjected to the X-ray diffraction analysis using the X-ray diffraction device (MiniFlex manufactured by Rigaku Corporation). Measurement conditions were such that a scan axis was set to 2θ/θ. CuKα was used as a radiation source. In addition, the X-ray diffraction analysis was performed using a continuous measurement method under conditions of voltage 40 kV, current 15 mA, start angle 2θ=5°, end angle 2θ=90°, sampling width 0.020°, and scan speed 10.000°/min.

A crystal structure was identified by comparing the X-ray diffraction pattern of the measurement sample with a database PDF-2 2023 of the International Centre for Diffraction Data using software PDXL2 manufactured by Rigaku Corporation. Furthermore, when the measurement sample was identified as boehmite, the crystallite diameter was calculated from the peak of the (020) plane of the boehmite using the above-mentioned method.

### (Confirmation of Crystal Shape and Aggregate)

The measurement sample was observed with the scanning electron microscope (SEM). It was confirmed that the crystals formed the aggregate. Note that as the scanning electron microscope, a scanning electron microscope S-5500 manufactured by Hitachi High-Tech Corporation was used. The magnification was set to 50,000 to 300,000 times. As image analysis software, Winroof 2018 STANDARD manufactured by Mitani Corporation was used.

### (Specific Surface Area)

The measurement sample collected in the magnetic crucible was fired at 600° C. for 2 hours. Thereafter, the measurement sample was placed in the desiccator and cooled to the room temperature. Subsequently, a specific surface area (m²/g) of 0.3 g of the measurement sample weighed was measured by the BET single-point method using the fully automatic surface area measuring device (Macsorb-1220 manufactured by Mountec Co., Ltd.).

### (CBD)

25 g of the measurement sample weighed out was transferred to a 250 ml measuring cylinder. The measuring cylinder was attached to a Tyler sieve shaker. The sample was filled by tapping with the Tyler sieve shaker over a period of 15 minutes, and then the measuring cylinder was removed from the Tyler sieve shaker. After the sample surface was flattened, the CBD was calculated from the filling volume that was read.

### Measurement of Fluid Catalytic Cracking Catalyst

### (Measurement Sample)

The fluid catalytic cracking catalysts obtained in Examples and Comparative Examples were used as the measurement samples.

### (Specific Surface Area)

The specific surface area of the fluid catalytic cracking catalyst was measured using a method similar to the method for measuring the specific surface area of the boehmite.

### (Powder X-Ray Diffraction Analysis)

The measurement sample pulverized in the mortar was subjected to the X-ray diffraction analysis using the X-ray diffraction device (MiniFlex manufactured by Rigaku Corporation). The measurement conditions were such that the scan axis was set to 2θ/θ. CuKα was used as the radiation source. In addition, the X-ray diffraction analysis was performed using the continuous measurement method under the conditions of voltage 40 kV, current 15 mA, start angle 2θ=5°, end angle 2θ=90°, sampling width 0.020°, and scan speed 10.000°/min.

Integrated intensities were calculated using software PDXL2 manufactured by Rigaku Corporation. The values of A/B and A/C were calculated from the integrated intensity (A) of the diffraction peak (2θ=14.0 to 15.0°) attributed to the (020) plane of the boehmite, the integrated intensity (B) of the diffraction peak (2θ=28.0 to 28.5°) attributed to the (120) plane of the boehmite, and the integrated intensity (C) of the diffraction peak (2θ=15.5 to 16.0°) attributed to the (331) plane of the ultra-stable Y-type zeolite.

### (Matrix Specific Surface Area)

The matrix specific surface area of the fluid catalytic cracking catalyst was measured before and after the pseudo-equilibrium treatment in a catalyst performance evaluation test described below.

The measurement sample collected in the magnetic crucible was fired at 600° C. for 2 hours. Thereafter, the measurement sample was placed in the desiccator and cooled to the room temperature. Subsequently, an adsorption amount of the measurement sample weighed was measured using a fully automatic nitrogen adsorption/desorption measuring device (BELSORP-mini manufactured by MicrotracBEL Corp.). The resulting adsorption isotherm was analyzed by a t-plot method using software BELMaster manufactured by MicrotracBEL Corp. Thus, the matrix specific surface area was determined.

Furthermore, the reduction rate of the matrix specific surface area by pseudo-equilibrium was calculated using the following formula.

$$Reduction rate of matrix specific surface area by pseudo - equilibrium ( \% ) = ( 1 - ( matrix specific surface area after pseudo - equilibrium treatment ) / ( matrix specific area before pseudo - equilibrium treatment ) ) \times 100 \%$$

### (Pore Volume)

The pore volume of the fluid catalytic cracking catalyst after the pseudo-equilibrium treatment was measured by the mercury intrusion porosimetry. The measurement sample collected in a magnetic crucible was heated at 500° C. for 1 hour. Thereafter, the measurement sample was placed in the desiccator and cooled to the room temperature. Thus, the measurement sample was obtained. Thereafter, the pore volume (ml/g) of the catalyst having a pore diameter of 4.0 to 10,000 nm was measured by the mercury intrusion porosimetry (Poremaster GT-60 manufactured by Quantachrome Corporation, mercury contact angle: 140 degrees, surface tension: 480 dyn/cm). Further, a ratio (m²/ml) of the matrix specific surface area (m²/g) after pseudo-equilibrium treatment to the pore volume (ml/g) was calculated.

### Production Example 1

### (Step 1: Preparation of Aggregated Boehmite by Hydrothermal Treatment)

0.12 kg of pseudo-boehmite powder (1) (Catapal-A manufactured by Sasol, concentration in terms of Al₂O₃ 71.2 mass %, d₅₀ (median diameter) on a volume basis 57 m), 0.72 kg of gibbsite powder (1) (C-303 manufactured by Sumitomo Chemical Co., Ltd., concentration in terms of Al₂O₃ 66.6 mass %, d₅₀ (median diameter) on a volume basis 6.1 μm), and 3.15 kg of ion-exchanged water were mixed. Thus, a slurry containing 14 mass % boehmite in terms of Al₂O₃ was obtained. While the slurry was being stirred, 20 g of a 48 mass % aqueous sodium hydroxide solution was added to the slurry. In this way, a uniform slurry (1) having a pH of 11.8 (pH measured at 60° C.; the same applies to other Production Examples and Comparative Production Examples) was obtained.

The slurry (1) was placed in a 5 L autoclave reactor and heated to 170° C. at a temperature rise rate of 25° C./hour while being stirred at a blade tip speed of 0.7 m/s. Thereafter, the slurry (1) was held at 170° C. for 4 hours under autogenous pressure. The slurry (1) was further stirred and allowed to cool naturally. Thus, a slurry (2) was obtained.

### (Step 2: Washing of Boehmite)

4.0 kg of the slurry (2) obtained in the step 1 was dehydrated under reduced pressure using a flat plate filtration device. Thereafter, the slurry (2) was washed with 20 L of 60° C. ion-exchanged water by throughflow. In this way, a washed cake (1) was obtained. A part of the washed cake (1) was placed on a stainless steel tray and dried at 130° C. for 12 hours. Thereafter, the washed cake (1) was thoroughly ground in the mortar. In this way, a powder (1) was obtained. The obtained powder (1) was measured by the method described above. It was confirmed that the powder (1) was the aggregate of plate-like boehmite crystals. Production conditions and measurement results are shown in Table 1.

### (Step 3: Preparation of Aggregated Boehmite Slurry)

The washed cake (1) was suspended in pure water. Thereafter, pH of the washed cake (1) was adjusted to 3.0 with sulfuric acid. In this way, a slurry of the aggregated boehmite (hereinafter referred to as aggregated boehmite slurry (1)) with a concentration of 15 mass % in terms of Al₂O₃ was obtained.

### Production Example 2

A holding time in the autoclave reactor was changed from 4 hours to 2 hours. Means and conditions other than this were the same as in the steps 1 and 2 of Production Example 1. In this way, a washed cake (2) and a powder (2) were obtained. It was confirmed that the powder (2) was the aggregate of plate-like boehmite crystals.

The production conditions and the measurement results are shown in Table 1. The washed cake (1) was changed to the washed cake (2). The means and conditions other than this were the same as those in the step 3 of Production Example 1. In this way, a slurry of the aggregated boehmite (hereinafter referred to as “aggregated boehmite slurry (2)”) with a concentration of 15 mass % in terms of Al₂O₃ was obtained.

### Production Example 3

The holding time in the autoclave reactor was changed from 4 hours to 14 hours. The means and conditions other than this were the same as those in the steps 1 and 2 of Production Example 1. In this way, a washed cake (3) and a powder (3) were obtained. It was confirmed that the powder (3) was the aggregate of plate-like boehmite crystals.

The production conditions and the measurement results are shown in Table 1. The washed cake (1) was changed to the washed cake (3). The means and conditions other than this were the same as those in the step 3 of Production Example 1. In this way, a slurry of the aggregated boehmite (hereinafter referred to as “aggregated boehmite slurry (3)”) with a concentration of 15 mass % in terms of Al₂O₃ was obtained.

### Production Example 4

The heating temperature (holding temperature) was changed from 170° C. to 160° C. Further, the holding time was changed from 4 hours to 5 hours. Furthermore, the blade tip speed was changed from 0.7 m/s to 1.4 m/s. The means and conditions other than this were the same as those in Production Example 1. In this way, a powder (4) was obtained. It was confirmed that the powder (4) was the aggregate of plate-like boehmite crystals. The production conditions and the measurement results are shown in Table 1.

### Production Example 5

The gibbsite powder (1) was changed to a gibbsite powder (2) (B-52 manufactured by Nippon Light Metal Co., Ltd., concentration in terms of Al₂O₃ 65.0 mass %, d₅₀ (median diameter) on a volume basis 52 μm). Further, the heating temperature (holding temperature) was changed from 170° C. to 160° C. Furthermore, the holding time was changed from 4 hours to 5 hours. The means and conditions other than this were the same as those in Production Example 1. In this way, a powder (5) was obtained. It was confirmed that the powder (5) was the aggregate of plate-like boehmite crystals. The production conditions and the measurement results are shown in Table 1.

### Comparative Production Example 1

9.09 kg of a 22 mass % aqueous sodium aluminate solution in terms of Al₂O₃ was placed in a tank with a steam jacket having a capacity of 200 L. Thereafter, 50.7 kg of ion-exchanged water was added to the tank. Subsequently, 231 g of a 26 mass % aqueous sodium gluconate solution was added to this solution. The resulting solution was heated until a temperature of the solution reached 60° C. while being stirred. In this way, a mixed solution of sodium aluminate and sodium gluconate was obtained.

Separately from the mixed solution, 14.29 kg of an aqueous aluminum sulfate solution having a concentration of 7 mass % in terms of Al₂O₃ was diluted with 25.71 kg of ion-exchanged water. Subsequently, the diluted aqueous solution was heated until its temperature reached 60° C. In this way, the aqueous aluminum sulfate solution was prepared.

Subsequently, while the mixed solution of sodium aluminate and sodium gluconate was being stirred, the aqueous aluminum sulfate solution was added to the mixed solution over a period of 10 minutes. During the stirring, the temperature of the mixed solution was maintained at 60° C. In this way, an alumina hydrate slurry having a concentration of 3.0 mass % in terms of Al₂O₃ was prepared. At this time, the pH of the slurry was 7.2. The obtained alumina hydrate slurry was aged at 60° C. for 60 minutes while being stirred. Subsequently, the aged alumina hydrate slurry was dehydrated under reduced pressure using the flat plate filtration device. Thereafter, the alumina hydrate slurry was washed with 100 L of ion-exchanged water at 60° C. The ion-exchanged water was added to a cake (c1) obtained by washing so that concentration of the alumina hydrate was 12 mass % in terms of Al₂O₃, to prepare a suspension. Thus, a pseudo-boehmite slurry (c1) was obtained.

A small amount of an analytical sample was extracted from this slurry and analyzed. As a result, particles in the slurry were pseudo-boehmite particles. The crystallite diameter was 3.9 nm. The d₅₀ (median diameter) on a volume basis was 4.4 μm.

1.40 kg of the pseudo-boehmite slurry (c1), 0.72 kg of the gibbsite powder (1), and 1.99 kg of the ion-exchanged water were mixed. In this way, a slurry having a pseudo-boehmite concentration of 14 mass % in terms of Al₂O₃ was prepared. While stirring the slurry, 20 g of a 48 mass % aqueous sodium hydroxide solution was added to the slurry. Thus, a uniform slurry having a pH of 11.8 was obtained.

Thereafter, the heating temperature (holding temperature) was changed from 170° C. to 160° C. The holding time was changed from 4 hours to 5 hours. The means and conditions other than this were the same as those in Production Example 1. Apowder (c1) produced in this way was measured. It was confirmed that the powder (c1) was a dispersion of the plate-like boehmite crystals. The production conditions and the measurement results are shown in Table 1.

### Comparative Production Example 2

An amount of the pseudo-boehmite powder (1) was changed to 0.24 kg. An amount of the gibbsite powder (1) was changed to 0.59 kg. The heating temperature (holding temperature) was changed from 170° C. to 160° C. The holding time was changed from 4 hours to 5 hours. The means and conditions other than this were the same as those in Production Example 1. A powder (c2) produced in this way was measured. It was confirmed that the powder (c2) was a dispersion of the plate-like boehmite crystals. The production conditions and the measurement results are shown in Table 1.

### Comparative Production Example 3

The heating temperature (holding temperature) was changed from 160° C. to 120° C. The holding time was changed from 4 hours to 5 hours. The means and conditions other than this were the same as those in Production Example 1. A powder (c3) produced in this way was measured. In the X-ray diffraction pattern of the powder (c3), the diffraction pattern of the gibbsite and the diffraction pattern of the boehmite were mixed. The integrated intensity of the (002) plane of the gibbsite was 24% of the integrated intensity of the (020) plane of the boehmite. It was confirmed that the powder (c3) was a mixture of the boehmite and the gibbsite. The production conditions and the measurement results are shown in Table 1.

### Comparative Production Example 4

When mixing the pseudo-boehmite powder (1), the gibbsite powder (1), and the ion-exchanged water, 23.3 g of a SiO₂ source (water glass manufactured by JGC Catalysts and Chemicals Ltd., SiO₂ concentration 24 mass %) was further mixed. Concentration of the SiO₂ source was set to 2.0 mass % in terms of SiO₂ based on a total amount (in terms of Al₂O₃) of the pseudo-boehmite powder (1) and the gibbsite powder (1) as a reference (100 mass %). The heating temperature (holding temperature) was changed from 170° C. to 160° C. The holding time was changed from 4 hours to 5 hours. The means and conditions other than this were the same as those in Production Example 1. A powder (c4) produced in this way was measured. It was confirmed that the powder (c4) was the gibbsite. The production conditions and the measurement results are shown in Table 1.

### Comparative Production Example 5

When mixing the pseudo-boehmite powder (1), the gibbsite powder (1), and the ion-exchanged water, 5.6 g of tartaric acid (L(+)-tartaric acid manufactured by Kanto Chemical Co., Inc., special grade) was further mixed. Concentration of the tartaric acid was set to 1.0 mass % based on the total amount (in terms of Al₂O₃) of the pseudo-boehmite powder (1) and the gibbsite powder (1) as a reference (100 mass %). The heating temperature (holding temperature) was changed from 170° C. to 160° C. The holding time was changed from 4 hours to 5 hours. The means and conditions other than this were the same as those in Production Example 1. The powder (c5) produced in this way was measured. It was confirmed that the powder (c5) was the gibbsite. The production conditions and the measurement results are shown in Table 1.

TABLE 1

| | | | | | | | | Com- | Com- | Com- | Com- | Com- |
|---|---|---|---|---|---|---|---|---|---|---|---|---|
| | | | | | | | | parative | parative | parative | parative | parative |
| | | | Pro- | Pro- | Pro- | Pro- | Pro- | Pro- | Pro- | Pro- | Pro- | Pro- |
| | | | duction | duction | duction | duction | duction | duction | duction | duction | duction | duction |
| | | | Exam- | Exam- | Exam- | Exam- | Exam- | Exam- | Exam- | Exam- | Exam- | Exam- |
| | | | ple 1 | ple 2 | ple 3 | ple 4 | ple 5 | ple 1 | ple 2 | ple 3 | ple 4 | ple 5 |
| Aggregated boehmite slurry | | | (1) | (2) | (3) | | | | | | | |
| Preparation conditions | | | | | | | | | | | | |
| Raw | Ratio of | parts | 15 | 15 | 15 | 15 | 15 | 15 | 30 | 15 | 15 | 15 |
| materials | pseudo- | by | | | | | | | | | | |
| | boehmite | mass | | | | | | | | | | |
| | powder | | | | | | | | | | | |
| | Ratio of | parts | 8 [symbol] | 8 [symbol] | 8 [symbol] | 8 [symbol] | 8 [symbol] | 8 [symbol] | 70 | 8 [symbol] | 8 [symbol] | 8 [symbol] |
| | gibbsite | by | | | | | | | | | | |
| | powder | mass | | | | | | | | | | |
| | [symbol] of gibbsite | μm | 6.1 | 6.1 | 6.1 | 6.1 | 52 | 6.1 | 6.1 | 6.1 | 6.1 | 6.1 |
| | powder | | | | | | | | | | | |
| | Crystallite | μm | 2.7 | 2.7 | 2.7 | 2.7 | 2.7 | 3.9 | 2.7 | 2.7 | 2.7 | 2.7 |
| | diameter | | | | | | | | | | | |
| | of pseudo- | | | | | | | | | | | |
| | boehmite | | | | | | | | | | | |
| | [symbol] of pseudo- | μm | 57 | 57 | 57 | 57 | 57 | 4.4 | 57 | 57 | 57 | 57 |
| | boehmite | | | | | | | | | | | |
| | Additional | | No | No | No | No | No | No | No | No | SiO₂ | Tartaric |
| | component | | addi- | addi- | addi- | addi- | addi- | addi- | addi- | additives | 2.0 | acid |
| | (amount added | | tives | tives | tives | tives | tives | tives | tives | | mass | 1.0 |
| | based | | | | | | | | | | % | mass |
| | on Al₂O₃) | | | | | | | | | | | % |
| Hydro- | pH of slurry | | 11.8 | 11.8 | 11.8 | 11.8 | 11.8 | 11.7 | 11.5 | 11.8 | 11.9 | 11.4 |
| thermal | before | | | | | | | | | | | |
| con- | hydrothermal | | | | | | | | | | | |
| ditions | treatment | | | | | | | | | | | |
| | Blade tip | m/s | 0.7 | 0.7 | 0.7 | 1.4 | 0.7 | 0.7 | 0.7 | 0.7 | 0.7 | 0.7 |
| | speed | | | | | | | | | | | |
| | Holding | ° C. | 170 | 170 | 170 | 160 | 160 | 160 | 160 | 120 | 160 | 160 |
| | temperature | | | | | | | | | | | |
| | Holding time | hr | 4 | 2 | 14 | 5 | 5 | 5 | 5 | 5 | 5 | 5 |
| | Temperature | ° C./hr | 25 | 25 | 26 | 25 | 25 | 25 | 25 | 25 | 25 | 25 |
| | rise rate | | | | | | | | | | | |
| Physical properties | | | | | | | | | | | | |
| | Crystallite | nm | 28 | 21 | 36 | 27 | 29 | 21 | 24 | — | — | — |
| | diameter | | | | | | | | | | | |
| | Particle size | μm | 7 | 7 | 6 | 7 | 8 | 7 | 7 | — | — | — |
| | distribution | | | | | | | | | | | |
| | ( [symbol] ) | | | | | | | | | | | |
| | Specific | m²/g | 187 | 121 | 99 | 102 | 98 | 163 | 111 | — | — | — |
| | surface area | | | | | | | | | | | |
| | CBD | g/ml | 0.31 | 0.3 | 0.37 | 0.3 | 0.38 | 0.65 | 0.63 | | | |
| | Crystalline | — | Boeh- | Boeh- | Boeh- | Boeh- | Boeh- | Boeh- | Boeh- | Boehmite + | Gibbsite | Gibbsite |
| | form | | mite | mite | mite | mite | mite | mite | mite | Gibbsite | | |

[symbol]

indicates data missing or illegible when filed

### Production of Fluid Catalytic Cracking Catalyst

### Example 1

### Production of Fluid Catalytic Cracking Catalyst (1)

2941 g of water glass (SiO₂ concentration 17 mass %) and 1059 g of sulfuric acid with a concentration of 25 mass % were added simultaneously and continuously to a vessel to prepare 4000 g of silica binder solution with a SiO₂ concentration of 12.5 mass %. 706 g of kaolin (solid concentration 85 mass %), 4167 g of the aggregated boehmite slurry (1) (Al₂O₃ concentration 15 mass %) obtained in Production Example 1 as crystalline boehmite, and 1014 g of powder (solid content concentration 74 mass %) of ultra-stable Y-type zeolite (manufactured by JGC Catalysts and Chemicals Ltd., UCS 2.445 nm, and SiO₂/Al₂O₃ molar ratio 7.1 determined by fluorescent X-ray measurement) were added to this silica binder solution and thoroughly stirred. In this way, a mixed slurry was prepared. The solid content concentration of the prepared mixed slurry was 25.0%. The temperature of the slurry was 39° C. The viscosity of the slurry was 800 mPa·s.

The mixed slurry was formed into droplets and spray-dried using a spray dryer under conditions of an inlet temperature of 250° C. and an outlet temperature of 150° C. Thus, spherical spray-dried particles with an average particle diameter of 70 μm were obtained.

The resulting spray-dried particles were washed with warm water. Subsequently, the spray-dried particles were subjected to ion exchange treatment using an aqueous ammonium sulfate solution. The spray-dried particles were further washed with warm water. Further, the spray-dried particles were subjected to ion exchange treatment using an aqueous rare earth metal chloride (LaCl₃) solution to a concentration of 1.0 mass % in terms of RE₂O₃. Thereafter, the resulting catalyst particles were dried for 10 hours in a dryer at an atmosphere of 150° C. In this way, a fluid catalytic cracking catalyst (1) was obtained. Composition and physical properties of the catalyst (1) are shown in Table 2.

### Example 2

### Production of Fluid Catalytic Cracking Catalyst (2)

The aggregated boehmite slurry (1) was changed to 4,167 g of the aggregated boehmite slurry (2) (Al₂O₃ concentration 15 mass %) obtained in Production Example 2. The means and conditions other than this were the same as those in Example 1. In this way, a fluid catalytic cracking catalyst (2) was obtained. The composition and physical properties of the catalyst (2) are shown in Table 2.

### Example 3

### Production of Fluid Catalytic Cracking Catalyst (3)

The aggregated boehmite slurry (1) was changed to 4,167 g of the aggregated boehmite slurry (3) (Al₂O₃ concentration 15 mass %) obtained in Production Example 3. The means and conditions other than this were the same as those in Example 1. In this way, a fluid catalytic cracking catalyst (3) was obtained. The composition and physical properties of the catalyst (3) are shown in Table 2.

### Example 4

### Production of Fluid Catalytic Cracking Catalyst (4)

An amount of the powder of the ultra-stable Y-type zeolite was changed to 845 g, and an amount of the kaolin was changed to 853 g. The means and conditions other than this were the same as those in Example 1. In this way, a fluid catalytic cracking catalyst (4) was obtained. The composition and physical properties of the catalyst (4) are shown in Table 2.

### Example 5

### Production of Fluid Catalytic Cracking Catalyst (5)

As raw materials for the mixed slurry, 833 g of microcrystalline boehmite slurry (manufactured by JGC Catalysts and Chemicals Ltd., Al₂O₃ concentration 15.0 mass %, crystallite diameter 3 nm) and 833 g of gibbsite slurry (manufactured by JGC Catalysts and Chemicals Ltd., Al₂O₃ concentration 15.0 mass %) were further used. Furthermore, an amount of the aggregated boehmite slurry (1) was changed to 2500 g. The means and conditions other than this were the same as those in Example 1. In this way, a fluid catalytic cracking catalyst (5) was obtained. The composition and physical properties of the catalyst (5) are shown in Table 2.

### Comparative Example 1

### Production of Fluid Catalytic Cracking Catalyst (c1)

The aggregated boehmite slurry (1) was changed to 4,167 g of microcrystalline boehmite slurry (manufactured by JGC Catalysts and Chemicals Ltd., Al₂O₃ concentration: 15.0 mass %, crystallite diameter: 3 nm, dispersion medium: water, boehmite crystals are dispersed without aggregation). The means and conditions other than this were the same as those in Example 1. In this way, a fluid catalytic cracking catalyst (c1) was obtained. The composition and physical properties of the catalyst (ci) are shown in Table 2.

### Comparative Example 2

### Production of Fluid Catalytic Cracking Catalyst (c2)

The aggregated boehmite slurry (1) was changed to 4,167 g of highly dispersed crystalline boehmite slurry (manufactured by JGC Catalysts and Chemicals Ltd., Al₂O₃ concentration: 15.0 mass %, crystallite diameter: 23 nm, dispersion medium: water, median diameter: 0.29 μm, boehmite crystals are dispersed without aggregation). The means and conditions other than this were the same as those in Example 1. In this way, a fluid catalytic cracking catalyst (c2) was obtained. The composition and physical properties of the catalyst (c2) are shown in Table 2.

### Comparative Example 3

### Production of Fluid Catalytic Cracking Catalyst (c3)

As the raw materials for the mixed slurry, 1667 g of microcrystalline boehmite slurry (manufactured by JGC Catalysts and Chemicals Ltd., Al₂O₃ concentration: 15.0 mass %, crystallite diameter: 3 nm, dispersion medium: water, boehmite crystals are dispersed without aggregation) and 833 g of gibbsite (manufactured by JGC Catalysts and Chemicals Ltd., Al₂O₃ concentration: 15.0 mass %) were further used. The amount of the aggregated boehmite slurry (1) was changed to 1667 g. The means and conditions other than this were the same as those in Example 1. In this way, a fluid catalytic cracking catalyst (c3) was obtained. The composition and physical properties of the catalyst (c3) are shown in Table 2.

### Evaluation of Fluid Catalytic Cracking Catalyst

Using the same crude oil and under the same reaction conditions, the performance evaluation test of the fluid catalytic cracking catalyst was carried out for Examples and Comparative Examples. An advanced cracking evaluation micro activity test (ACE-MAT manufactured by Kayser Technology, Inc., Model R+) was used for the test. The results are shown in Table 2.

However, prior to these performance evaluation tests, the pseudo-equilibrium treatment was carried out on the catalyst using nickel and vanadium in advance, in order to simulate a state in which the catalyst had been subjected to hydrothermal degradation in a catalyst regeneration tower. Specifically, a toluene solution containing nickel octylate and vanadium octylate was absorbed into the catalyst so that the nickel concentration was 1000 ppm and the vanadium concentration was 2000 ppm. Here, the nickel concentration was calculated by dividing mass of nickel by the mass of the catalyst. The vanadium concentration was calculated by dividing mass of vanadium by the mass of the catalyst. Thereafter, the catalyst was fired at 600° C. for 1.5 hours to be deposited. Thereafter, the catalyst was further steamed at 780° C. for 13 hours. In this manner, the pseudo-equilibrium treatment was carried out.

### Operating Conditions

The reaction conditions for the catalyst performance evaluation test are as follows.

Feedstock oil: Desulfurized atmospheric residual oil (DSAR)+desulfurized vacuum gas oil (DSVGO) (50+50) of crude oil

Mass ratio of catalyst/oil throughput (C/O): 3.75 and 5.0 (mass %/mass %)

Reaction temperature: 520° C.
1) Conversion rate=100−(LCO+HCO) (mass %)
2) Boiling point range of gasoline: 30 to 216° C.
3) Boiling point range of light cycle oil (LCO): 216 to 343° C.
4) Boiling point range of heavy cycle oil (HCO): 343° C.+
5) Liquid petroleum gas (LPG)
6) LPG olefinicity: Proportion (mass ratio) of propylene and butenes in LPG having 3 to 4 carbon atoms

Selectivity at conversion rate of 73%: A simple regression line was created from the conversion rate at C/O=3.75 and the yield of each component, and the conversion rate at C/O=5.0 and the yield of each component. The selectivity of each component at a conversion rate of 73% was calculated from the simple regression line.

TABLE 2

| | | | | | | | | Com- | Com- | Com- |
|---|---|---|---|---|---|---|---|---|---|---|
| | | | | | | | | parative | parative | parative |
| | | | Exam- | Exam- | Exam- | Exam- | Exam- | Exam- | Exam- | Exam- |
| | | | ple 1 | ple 2 | ple 3 | ple 4 | ple 5 | ple 1 | ple 2 | ple 3 |
| Fluid catalytic cracking catalyst | | | 1 | 2 | 3 | 4 | 5 | C1 | C2 | C3 |
| Composition | Microcrystalline boehmite | mass % | | | | | 5 | 2 [symbol] | | 10 |
| | Gibbsite | mass % | | | | | 5 | | | 5 |
| | Highly dispersed | mass % | | | | | | | 25 | |
| | crystalline boehmite | | | | | | | | | |
| | Aggregated boehmite | mass % | 25 | | | 2 [symbol] | 15 | | | 10 |
| | (Aggregated bochmite slurry (1)) | | | | | | | | | |
| | Aggregated boehmite | mass % | | 25 | | | | | | |
| | (Aggregated boehmite slurry (2)) | | | | | | | | | |
| | Aggregated boehmite | mass % | | | 25 | | | | | |
| | (Aggregated boehmite slurry (3)) | | | | | | | | | |
| | Zeolite | mass % | 30 | 30 | 30 | 25 | 30 | 30 | 30 | 30 |
| | Kaolin | mass % | 24 | 24 | 24 | 29 | 24 | 24 | 24 | 24 |
| | Silica binder | mass % | 20 | 20 | 20 | 20 | 20 | 20 | 20 | 20 |
| | RE₂O₃ | mass % | 1 | 1 | 1 | 1 | 1 | 1 | 1 | 1 |
| Physical | Specific surface area | m²/g | 241 | 257 | 237 | 207 | 261 | 279 | 229 | 264 |
| properties | AC (XRD bochmite | — | 1.1 | 1.2 | 1.4 | 1.3 | 0.9 | 0.5 | 1.5 | 0.6 |
| | 020/zeolite 331) | | | | | | | | | |
| | A/B (XRD boehmite | — | 1.1 | 1.1 | 1.1 | 1.1 | 1.1 | 0.9 | 1.3 | 1.3 |
| | 020/boehmite 120) | | | | | | | | | |
| | Matrix specific surface | m²/g | 33 | 38 | 26 | 29 | 38 | 71 | 28 | 46 |
| | area after pseudo- | | | | | | | | | |
| | equilibrium treatment | | | | | | | | | |
| | Reduction rate of matrix | % | 54 | 46 | 59 | 56 | 49 | 35 | 31 | 36 |
| | specific surface area | | | | | | | | | |
| | by pseudo-equilibrium | | | | | | | | | |
| | (Matrix specific surface | m²/g | 113 | 104 | 110 | 104 | 99 | 268 | 76 | 142 |
| | area after pseudo-equilibrium | | | | | | | | | |
| | treatment)/(Pore volume) | | | | | | | | | |
| Evaluation of fluid catalytic cracking catalyst | | | | | | | | | | |
| Conversion rate (mass%) at C/O = 6 | | | 76.1 | 76.1 | 74.3 | 74.1 | 75.5 | 76.1 | 74.2 | 76.7 |
| Selectivity at | H2 Yield | mass % | 0.4 | 0.5 | 0.4 | 0.4 | 0.4 | 0.6 | 0.4 | 0.5 |
| 73% | C1 + C2 Yield | mass % | 1.7 | 1.8 | 1.6 | 1.5 | 1.7 | 1.8 | 1.7 | 1.8 |
| conversion | LPG Yield | mass % | 14.3 | 14.2 | 14.3 | 14.2 | 14.3 | 13.7 | 14.3 | 14.1 |
| rate | Gasoline Yield | mass % | 51.6 | 51.4 | 51.9 | 52.1 | 51.4 | 50.0 | 51.6 | 50.7 |
| | LCO Yield | mass % | 18.1 | 18.4 | 18.0 | 18.3 | 18.2 | 18.3 | 17.3 | 18.2 |
| | HCO Yield | mass % | 8.9 | 8.6 | 9.0 | 8.7 | 8.8 | 8.7 | 9.7 | 8.8 |
| | Coke Yield | mass % | 5.0 | 5.1 | 4.8 | 4.8 | 6.2 | 6.9 | 5.0 | 5.9 |
| | LPG Olefinicity | | 0.68 | 0.67 | 0.69 | 0.70 | 0.68 | 0.65 | 0.65 | 0.64 |

[symbol]

indicates data missing or illegible when filed

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A fluid catalytic cracking catalyst comprising faujasite-type zeolite, boehmite, a binder, and clay minerals, and satisfying the following formulas (1) and (2) in powder X-ray diffraction analysis:
$$A / B \leq 1.2 \qquad ( 1 )$$
$$A / C \geq 0.8 \qquad ( 2 )$$
in the formulas (1) and (2), A is an integrated intensity of a diffraction peak attributed to (020) plane of the boehmite, B is an integrated intensity of a diffraction peak attributed to (120) plane of the boehmite, and C is an integrated intensity of a diffraction peak attributed to (331) plane of the faujasite-type zeolite.

2. The fluid catalytic cracking catalyst according to claim 1, wherein
a matrix specific surface area determined by t-plot analysis of a nitrogen adsorption isotherm obtained by measuring the fluid catalytic cracking catalyst after pseudo-equilibrium treatment is 10 to 40 m²/g, and
the pseudo-equilibrium treatment includes steaming the fluid catalytic cracking catalyst carrying 1000 ppm of nickel and 2000 ppm of vanadium at 780° C. for 13 hours.

3. The fluid catalytic cracking catalyst according to claim 1, satisfying the following formula (3):
$$( 1 - ( matrix specific surface area after pseudo - equilibrium treatment ) / ( matrix specific area before pseudo - equilibrium treatment ) ) \times 100 \% \geq 40 \% \qquad ( 3 )$$
in the formula (3), the matrix specific surface area after pseudo-equilibrium treatment is a matrix specific surface area determined by t-plot analysis of the nitrogen adsorption isotherm obtained by measuring the fluid catalytic cracking catalyst after the pseudo-equilibrium treatment,
the matrix specific surface area before pseudo-equilibrium treatment is a matrix specific surface area determined by the t-plot analysis of the nitrogen adsorption isotherm obtained by measuring the fluid catalytic cracking catalyst before the pseudo-equilibrium treatment, and
the pseudo-equilibrium treatment includes steaming the fluid catalytic cracking catalyst carrying 1000 ppm of nickel and 2000 ppm of vanadium at 780° C. for 13 hours.

4. The fluid catalytic cracking catalyst according to claim 1, satisfying the following formula (4):
$$( matrix specific surface area after pseudo - equilibrium treatment ) / ( pore volume ) \leq 120 {m}^{2} / ml \qquad ( 4 )$$
in the formula (4), the matrix specific surface area after pseudo-equilibrium treatment is a matrix specific surface area determined by t-plot analysis of the nitrogen adsorption isotherm obtained by measuring the fluid catalytic cracking catalyst after the pseudo-equilibrium treatment,
the pore volume is a volume of pores having a pore diameter of 4.0 to 10,000 nm obtained by measuring the fluid catalytic cracking catalyst after the pseudo-equilibrium treatment by mercury intrusion porosimetry, and
the pseudo-equilibrium treatment includes steaming the fluid catalytic cracking catalyst carrying 1000 ppm of nickel and 2000 ppm of vanadium at 780° C. for 13 hours.

5. The fluid catalytic cracking catalyst according to claim 1, wherein the boehmite forms a card house structure.

6. The fluid catalytic cracking catalyst according to claim 1, wherein the boehmite is an aggregate of boehmite crystals having following properties (i) to (iv):
(i) a crystallite diameter calculated from a peak of (020) plane of the boehmite crystal in X-ray diffraction measurement is 10 to 70 nm;
(ii) a specific surface area of the aggregate measured by a nitrogen adsorption method is 40 to 150 m²/g;
(iii) a d₅₀ median diameter on a volume basis of the aggregate in particle size distribution measured by a laser diffraction/scattering method is 2.0 to 10 μm; and
(iv) a compact bulk density (CBD) of the aggregate is 0.20 to 0.50 g/ml.

7. The fluid catalytic cracking catalyst according to claim 1, wherein a content of the boehmite in terms of Al₂O₃ is 5 to 50 mass %.

8. The fluid catalytic cracking catalyst according to claim 1, wherein the faujasite-type zeolite is an ultra-stable Y-type zeolite.

9. The fluid catalytic cracking catalyst according to claim 1, wherein a content of the faujasite-type zeolite is 20 to 40 mass %.

10. The fluid catalytic cracking catalyst according to claim 1, comprising 0.5 to 3.5 mass % of rare earth metal RE in terms of oxide RE₂O₃.

11. The fluid catalytic cracking catalyst according to claim 1, wherein a content of the clay minerals is 15 to 50 mass %.

12. The fluid catalytic cracking catalyst according to claim 1, wherein a specific surface area measured by a nitrogen adsorption method is 200 to 350 m²/g.

13. A method for producing a fluid catalytic cracking catalyst, the method comprising following steps α, β, and γ in this order:
a step α of preparing an aggregate of boehmite crystals having following properties (i) to (iv):
(i) a crystallite diameter calculated from a peak of (020) plane of the boehmite crystal in X-ray diffraction measurement is 10 to 70 nm;
(ii) a specific surface area of the aggregate measured by a nitrogen adsorption method is 40 to 150 m²/g;
(iii) a d₅₀ median diameter on a volume basis of the aggregate in particle size distribution measured by a laser diffraction/scattering method is 2.0 to 10 m; and
(iv) a compact bulk density (CBD) of the aggregate is 0.20 to 0.50 g/ml,
a step β of preparing a catalyst raw material slurry containing faujasite-type zeolite, the aggregate of boehmite crystals, a binder-forming component, and clay minerals; and
a step γ of spray drying the catalyst raw material slurry to form particles.

14. The method for producing the fluid catalytic cracking catalyst according to claim 13, wherein
the step α comprises a first step, a second step, and a third step in this order:
a first step of mixing gibbsite, non-deflocculated pseudo-boehmite, and water so as not to have a pH of 7.0 or less to prepare a mixed liquid 1;
a total amount of the gibbsite and the pseudo-boehmite in the mixed liquid 1 is 100 parts by mass in terms of Al₂O₃,
an amount of the gibbsite in the mixed liquid 1 is 75 to 95 parts by mass in terms of Al₂O₃,
an amount of the pseudo-boehmite in the mixed liquid 1 is 5 to 25 parts by mass in terms of Al₂O₃,
a median diameter d₅₀ on a volume basis of the gibbsite in the particle size distribution measured by the laser diffraction/scattering method is 1.0 to 1.5 μm or more and less than 70 μm,
a crystallite diameter calculated from the peak of the (020) plane of the pseudo-boehmite in the X-ray diffraction measurement is 2 to 6 nm, and
a median diameter d₅₀ on a volume basis of the pseudo-boehmite in the particle size distribution measured by the laser diffraction/scattering method is 5 to 100 μm,
a second step of adding an inorganic basic compound to the mixed liquid 1 to prepare a mixed liquid 2 having a pH of 9 to 12; and
a third step of raising a temperature of the mixed liquid 2 at a rate of 15 to 60° C./hour, and hydrothermally treating the mixed liquid 2 at 150 to 190° C. for 1 to 24 hours while stirring the mixed liquid 2 to produce a slurry of the aggregate of boehmite crystals.

15. The method for producing the fluid catalytic cracking catalyst according to claim 13, wherein in the step 3, the catalyst raw material slurry has a solid content concentration of 20 to 40 mass %, a temperature of the catalyst raw material slurry is 20 to 80° C., and a viscosity of the catalyst raw material slurry is 100 to 10,000 mPa·s.
